(19) United States
(12) Patent Application Publication
(10) Pub. No.: US 2017/0045766 A1
(43) Pub. Date: Feb. 16, 2017

(54) ELECTRONIC DEVICE AND METHOD FOR MANUFACTURING SAME

(71) Applicant: Sharp Kabushiki Kaisha, Sakai City, Osaka (JP)

(72) Inventors: Minoru MAKINO, Sakai City (JP); Kenzoh DAIMON, Sakai City (JP)

(73) Assignee: Sharp Kabushiki Kaisha, Sakai city, Osaka (JP)

(21) Appl. No.: 15/305,355

(22) PCT Filed: May 14, 2015
(86) PCT No.: PCT/JP2015/002449

§ 371 Date: Oct. 20, 2016

(30) Foreign Application Priority Data
May 19, 2014 (JP) 2014-103569

(51) Int. Cl. G02F 1/1335; F21V 8/00

(52) U.S. Cl. CPC G02F 1/1335; G02B 6/0055; G02F 2202/28

(57) ABSTRACT

The front of a fixing optical sheet (24) is bonded to the back of a liquid crystal display panel (22) having a rectangular plate shape. The front of a rectangular plate-shaped backlight unit (30) is brought into contact with the back of the fixing optical sheet (24). Extension portions (24b) extending from the four sides of the fixing optical sheet (24) are bonded to the four side portions of the back of the backlight unit (30). In this manner, a narrow picture frame of the liquid crystal display unit is achieved, while adopting a simple and easy-to-assemble structure.

### TECHNICAL FIELD

The present invention relates to an electronic device provided with a liquid crystal display unit, and a method for manufacturing the device.

### BACKGROUND ART

As shown in FIG. 7A, a liquid crystal display unit 102 included in an electronic device of known art has a wide picture-frame region C located outside a liquid crystal active area A. According to the known art, this wide picture-frame region C is utilized as a region where a backlight unit 130 is bonded to a liquid crystal display panel 122 with a piece of frame-shaped double-sided tape 123. Further, at least one optical sheet 125 of the backlight unit 130 is fixed to the front of the backlight unit 130 with this frame-shaped double-sided tape 123. The backlight unit 130 has a light guide plate 126 disposed in a backlight unit holder 129, and the back of the backlight unit 130 is covered with a reflector plate 127.

Since the backlight unit holder 129 has a sufficient bonding area D, one of the optical sheets 125 that is closest to the liquid crystal display panel 122 may also be bonded to the backlight unit holder 129, as shown in FIG. 7B.

Moreover, as shown in FIG. 7C, an LED 128 functioning as a light source is fixed with reference to the position of the backlight unit holder 129.

However, there is an increasing demand for the liquid crystal active area A to be as large as possible, and in order to meet this demand, the picture-frame region C is being designed narrower and narrower. This makes it difficult to utilize the picture-frame region C as a region where the liquid crystal unit 122 is bonded to the backlight unit holder 129, as in the known art.

In order to illuminate the entire liquid crystal display panel 122, a backlight effective light-emitting area B needs to be larger than the liquid crystal active area A. According to the structure of the known art, in order to ensure the bonding area D, it is necessary to design the backlight unit holder 129 larger than the liquid crystal display panel 122, resulting in that, despite the liquid crystal display panel 122 itself designed to have a narrow picture-frame region, the electronic device as a whole disadvantageously has a wide picture-frame region C.

A technique to address this problem is known from Patent Document 1, for example. According to this technique, a liquid crystal panel, a polarizing plate, and a backlight unit are stacked together, and the resultant stacked structure, including its front and lateral sides, is entirely covered with an optical adhesive film.

Patent Document 2 describes a liquid crystal display device in which a stacked structure comprised of optical elements is covered with a band-shaped packaging member such that the packaging member extends over the incidence plane, the outgoing plane, and the end faces of both short sides of the stacked structure, while the end faces of both long sides of the stacked structure are exposed. The ends in the longitudinal direction of the band-shaped packaging member are joined to each other on the end face of one of the short sides of the optical element stacked structure.

### CITATION LIST

### Patent Document

Patent Document 1: Japanese Unexamined Patent Publication No. 2012-103687

Patent Document 2: Japanese Unexamined Patent Publication No. 2008-197398

### SUMMARY OF THE INVENTION

### Technical Problem

However, in the electronic device described in Patent Document 1, the multilayer optical adhesive film, which is bonded to the front of the liquid crystal panel, adversely reduces the transmittance. Further, it is difficult to bond the optical adhesive film without allowing the entry of air bubbles or the displacement of the film. Furthermore, the liquid crystal panel, which is to be covered entirely with the optical adhesive film, has a side on which a flexible substrate extending from the liquid crystal panel is positioned and which is therefore difficult to cover with the optical adhesive film.

In the electronic device of Patent Document 2, the ends in the longitudinal direction of the band-shaped packaging member are merely joined to each other on the end face of the short side of the optical element stacked structure, and the other portions of the stacked structure are only covered with the packaging member without bonding between the stacked structure and the packaging member. It is therefore impossible to make the packaging member come into close contact with the optical element stacked structure covered by the packaging member, which may allow the stacked structure to move inside the packaging member.

To prevent the stacked structure from moving, it is necessary to bring the stacked structure and the packaging member into close contact by employing a heat-shrinkable high molecular material as the packaging member, and allowing the packaging member to shrink by application of heat after joining the ends of the packaging member.

Unfortunately, the heat shrinkage of such a heat-shrinkable high molecular material unavoidably produces wrinkles, which inevitably deteriorates the optical characteristics.

In view of the foregoing, it is therefore an object of the present invention to provide a narrow picture-frame of a liquid crystal display unit, while adopting a simple and easy-to-assemble structure.

### Solution to the Problem

To achieve the above object, according to the present invention, a backlight unit is wrapped with a fixing optical sheet bonded to the back of a liquid crystal display unit.

Specifically, the present invention is implemented as an electronic device provided with a liquid crystal display unit.

The electronic device includes:
a liquid crystal display panel having a rectangular plate shape;
a fixing optical sheet of which a front is bonded to a back of the liquid crystal display panel; and
a backlight unit which has a rectangular plate shape and which is fixed, with a front thereof being in contact with a back of the fixing optical sheet.

The fixing optical sheet has extension portions each of which extends from an associated one of four sides of the fixing optical sheet and is designed to be folded back to cover an associated one of four side portions of a back of the backlight unit, and
in a state where the fixing optical sheet is bonded to the back of the liquid crystal display panel, each of the extension portions is bonded to the associated one of the four side portions of the back of the backlight unit.

With this configuration, unlike the known art, it is no longer necessary to utilize the frame of the backlight unit holder as a region where the bonding is implemented. Consequently, even with the use of a liquid crystal display unit having a narrow picture-frame, the entire display area may be caused to glow without having to widen the picture-frame region. Further, the fixing optical sheet with which the backlight unit is wrapped does not extend from the front of the liquid crystal display unit, but is bonded to the back of the liquid crystal display unit. This may prevent a decrease in the transmittance. The configuration in which the back of the liquid crystal display unit is bonded with the fixing optical sheet hinders dust from entering between the back of the liquid crystal display unit and the backlight unit.

In addition, the configuration in which the extension portions are bonded to all of the four side portions of the back of the backlight unit substantially prevents the components forming the backlight unit from being displaced in any direction. This may increase not only the accuracy of position of each component, but also the strength, and may hinder dust from entering into the gaps between the components.

Further, the electronic device is not configured such that the ends of the fixing optical sheet are joined together, but has a configuration in which the back of the backlight unit, which has a high stiffness and is located frontward of the extension portions of the fixing optical sheet, is utilized to join the fixing optical sheet. With this configuration, the liquid crystal display panel and the backlight unit may be reliably held without deteriorating the optical characteristics.

### Advantages of the Invention

As can be seen from the foregoing, according to the present invention, the fixing optical sheet has the extension portions which are designed to be folded back to cover the four side portions of the back of the backlight unit. The extension portions are bonded to the four side portions of the back of the backlight unit in a state where the front of the fixing optical sheet is bonded to the back of the liquid crystal display panel. As a result, a liquid crystal display unit having a narrow picture-frame is provided, while adopting a simple and easy-to-assemble structure.

### BRIEF DESCRIPTION OF THE DRAWINGS

FIG. 1 shows an enlarged cross section taken along the plane I-I in FIG. 2, and a portion of the cross section on an enlarged scale.

FIG. 2 is a perspective view of a mobile telephone according to an embodiment of the present invention.

FIG. 3 is an exploded perspective view of a mobile telephone.

FIG. 4 is a perspective view of a liquid crystal display unit and a backlight unit, as viewed from the back.

FIG. 5A is a perspective view of a fixing optical sheet in an unfolded state.

FIG. 5B is a perspective view of a fixing optical sheet in a folded state.

FIG. 6 corresponds to FIG. 1 and shows, on an enlarged scale, a mobile telephone according to another embodiment.

FIG. 7A is a cross section of a liquid crystal display unit and a backlight unit according to known art.

FIG. 7B is a cross section of a liquid crystal display unit and a backlight unit according to known art.

FIG. 7C is a cross section of a liquid crystal display unit and a backlight unit according to known art.

FIG. 8 corresponds to FIG. 1 and shows a second embodiment of the present invention.

FIG. 9 corresponds to FIG. 1 and shows a variation of the second embodiment of the present invention.

FIG. 10A is a perspective view of a backlight transparent sheet before being folded.

FIG. 10B is a perspective view of the backlight transparent sheet in the course of being folded.

FIG. 10C is a perspective view of the folded backlight transparent sheet.

### DESCRIPTION OF EMBODIMENTS

Embodiments of the present invention will be described with reference to the drawings.

### First Embodiment

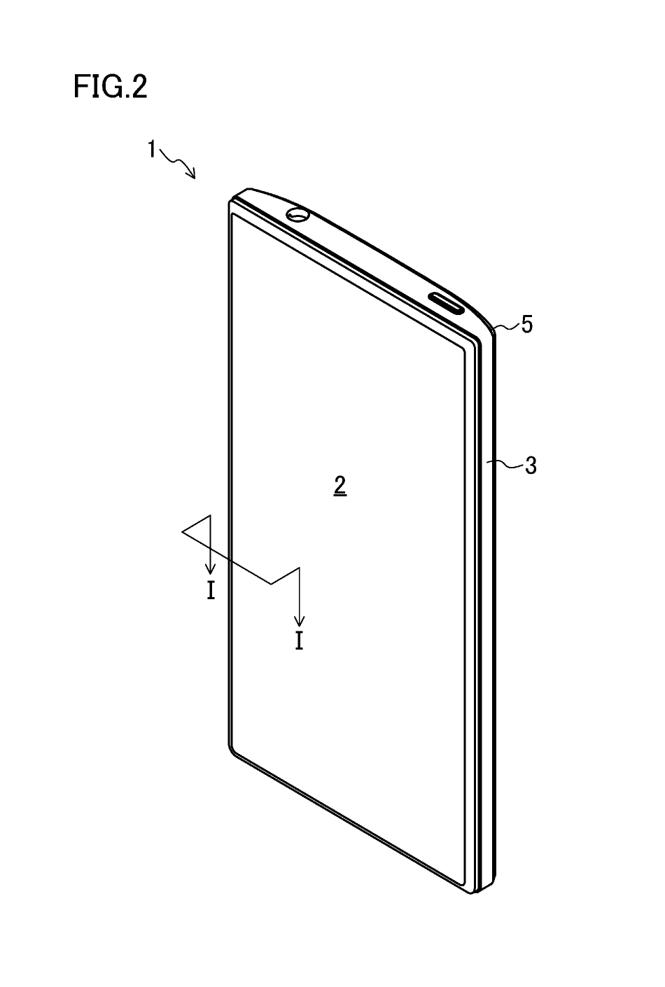

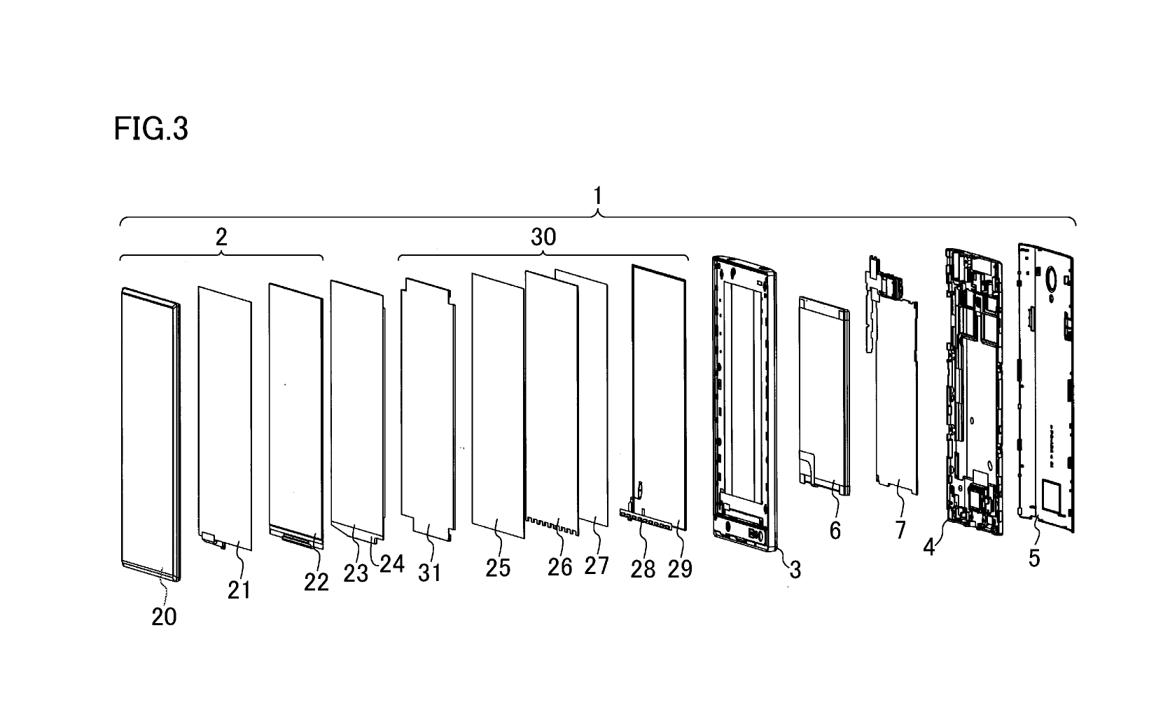

As shown in FIGS. 2 and 3, an electronic device according to this embodiment is configured as a mobile telephone 1. This mobile telephone 1 includes, for example, a front-side cabinet 3 at a front of which a liquid crystal display unit 2 is housed, a backside cabinet 4 which covers the back of the front-side cabinet 3, and a rear cover 5 which covers the back of the backside cabinet 4. A rechargeable battery 6, a main substrate 7, and other components are disposed between the front-side cabinet 3 and the backside cabinet 4.

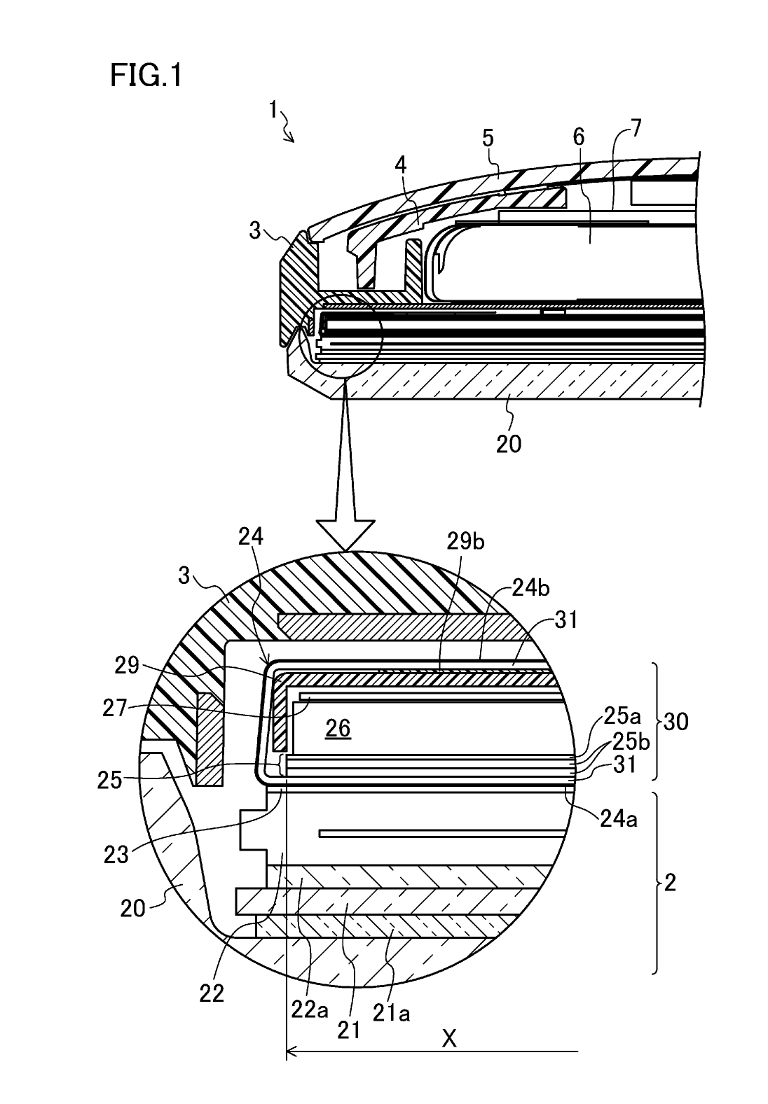

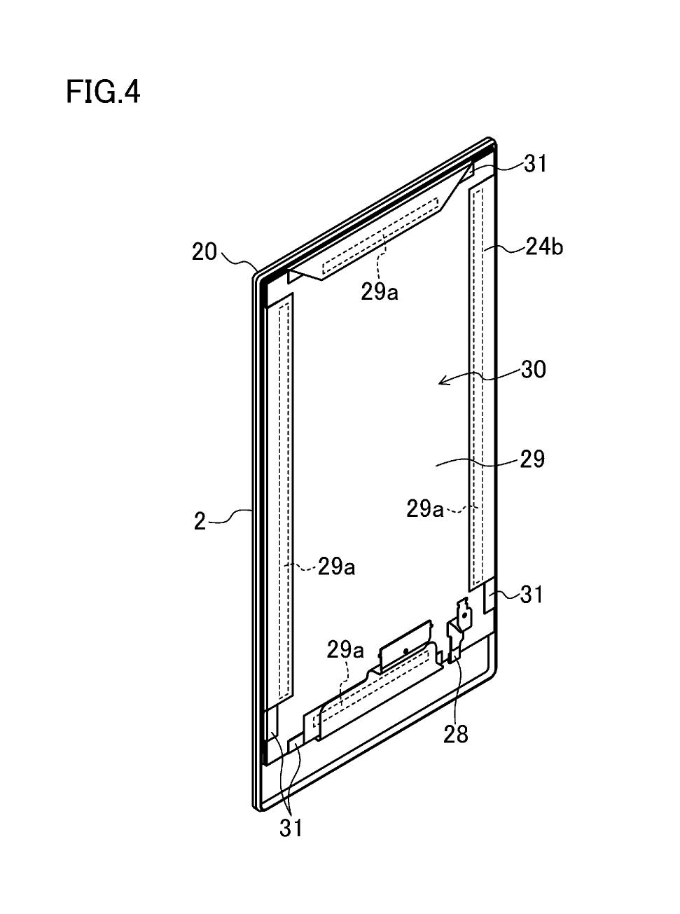

As shown in FIGS. 3 and 4, the liquid crystal display unit 2 has a front cover 20 which is comprised of a glass plate or an acrylic plate covering the front, for example. In this embodiment, the front cover 20 has its outer peripheral edge projecting backward. However, the front cover 20 may have a flat plate shape. A touch panel 21 is bonded to the back of the front cover 20. This touch panel 21 may be omitted, or may function also as the front cover 20. A liquid crystal display panel 22 having a rectangular plate shape is bonded to the back of the touch panel 21. Although the details of the liquid crystal display panel 22 are not shown, it includes, for example, a color filter substrate and an array substrate sandwiching a liquid crystal layer therebetween, polarizing plates covering the front and back of the liquid crystal display panel 22, and a printed wiring board having a drive LSI. As shown in FIGS. 1 and 4, a backlight unit 30 is fixed to the back of the liquid crystal display panel 22 with a fixing optical sheet 24 having a high light transmittance.

Specifically, the fixing optical sheet 24 is fixed to the back of the liquid crystal display panel 22 with a piece of optical clear adhesive tape 23 (OCA) which has a rectangular shape and a high light transmittance. The backlight unit 30 is fixed to the back of the liquid crystal display panel 22 with the fixing optical sheet 24 such that the front of the backlight unit 30 is in contact with the back of the liquid crystal display panel 22.

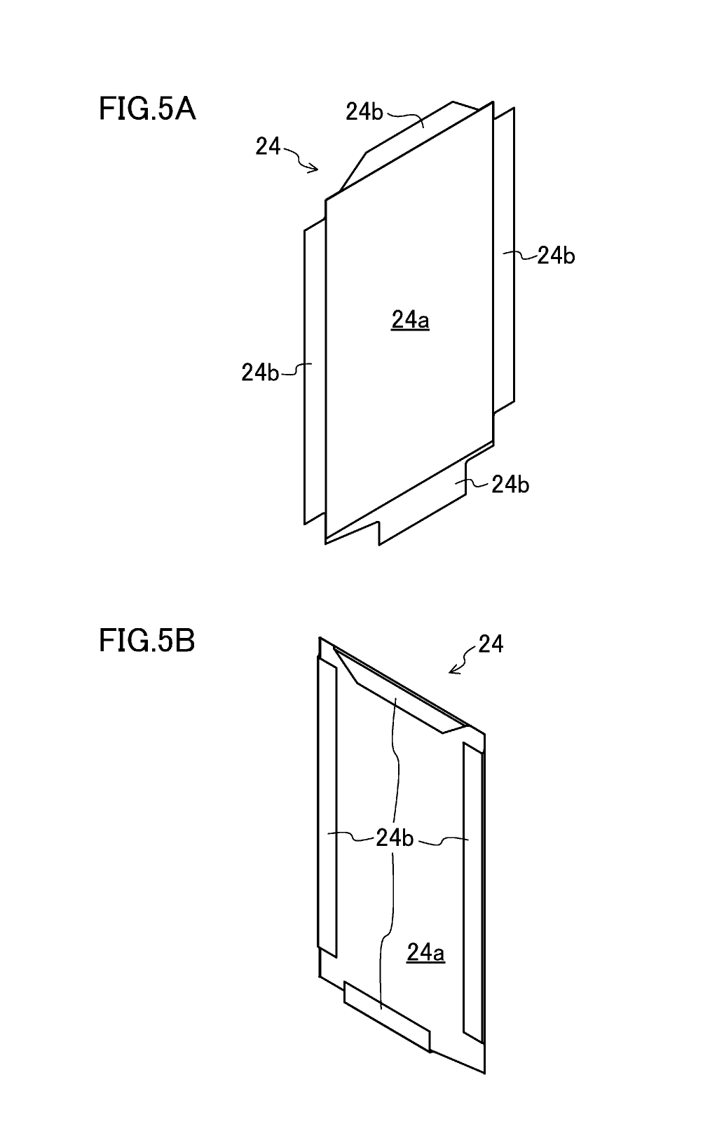

For example, the fixing optical sheet 24 includes a transparent and non-adhesive base material made of PET resin (polyethylene terephthalate) or PEN resin (polyethylene naphthalate) and having a film shape with a thickness of 10 μm-250 μm. The fixing optical sheet 24 is characterized by, for example, a high light transmittance that does not vary much due to a difference in wavelength of light, a small thickness, and a high strength. The fixing optical sheet 24 transmits the light emitted by the backlight unit 30 without loss toward the liquid crystal display panel 22, and reliably secures the liquid crystal display panel 22 and the backlight unit 30. As the fixing optical sheet 24, a sheet having asperities on its surface (part of a diffuser sheet or a lens sheet) may be used. The fixing optical sheet 24 beneficially reduces the occurrence of Newton's rings, if it has asperities on its surface. The film-shaped base material includes a rectangular body portion 24a which is designed to be bonded to the back of the liquid crystal display panel 22 with the optical clear adhesive tape 23. This base material has a small thickness, which reduces the total thickness of the fixing optical sheet 24. For example, the base material has flap-like and foldable extension portions 24b each extending from an associated one of the four sides, as shown in FIGS. 5A and 5B.

The backlight unit 30 has a thin bezel 29 which is a resin or metallic molding having a rectangular dish shape, for example. A reflector sheet 27 and a backlight substrate 28 including LEDs which function as light emitters and are spaced from one another are provided on this bezel 29. Inside the bezel 29, a light guide plate 26 having a rectangular plate shape is further arranged frontward of the reflector sheet 27 and the backlight substrate 28.

For example, the reflector sheet 27 has a multilayer structure of a polyester-based resin base material, and is formed by evaporating silver onto a PET (a polyester-based resin) film or stacking a PET (a polyester-based resin) film and metallic foil such as aluminum foil. The reflector sheet 27 has a thickness of, for example, 30 μm-300 μm, a high reflectance, and causes only small loss when reflecting light. The reflector sheet 27 reflects and returns light emitted in the direction opposite to the liquid crystal display panel 22 toward the liquid crystal display panel 22, thereby reducing loss of light and increasing the luminance of the liquid crystal display unit 2.

As indicated by the broken lines in FIG. 4, on the backside peripheral edge of the bezel 29 of the backlight unit 30, pieces of extension portion-fixing double-sided tape 29a are attached to portions where the extension portions 24b are to be bonded. These pieces of the extension portion-fixing double-sided tape 29a are arranged to bond the extension portions 24b. Note that the extension portions 24b may be bonded using an adhesive.

In this embodiment, as shown in FIG. 1 on an enlarged scale, a backlight transparent sheet 31 having a high light transmittance is arranged on the back of the body portion 24a. This backlight transparent sheet 31 is made of a material having a high light transmittance, such as a PET film or a PEN film, and has a thickness of 10 μm-250 μm, for example. The light transmittance of the backlight transparent sheet 31 does not vary much due to a difference in wavelength of light. The backlight transparent sheet 31 has a flat surface, a small thickness, and a high strength, and is colorless and transparent. The backlight transparent sheet 31 transmits the light emitted by the backlight unit 30 toward the liquid crystal display panel 22 without loss, and reliably holds the backlight unit 30. As the backlight transparent sheet 31, a sheet having asperities on its surface (part of a diffuser sheet or a lens sheet) may be used. In this embodiment, since a sheet with a flat surface is used as the fixing optical sheet 24, a diffuser sheet having asperities on its surface is used as the backlight transparent sheet 31 to reduce the occurrence of Newton's rings.

As shown also in FIG. 4, the backlight transparent sheet 31 is folded such that its four side portions extend on the back of the bezel 29. All of these four side portions are bonded by pieces of transparent sheet-fixing double-sided tape 29b shown in, for example, FIG. 1. This configuration enables the backlight unit 30 to be assembled into a unit in advance and mounted after being subjected to inspection or any other process step. An optical sheet 25 comprised, for example, of two lens sheets 25b and one diffuser sheet 25a is arranged over the back of the backlight transparent sheet 31. The backlight unit 30, in which the diffuser sheet 25a is in contact with the front of the light guide plate 26 and one of the lens sheets 25b is in contact with the front of the diffuser sheet 25a, is covered with the backlight transparent sheet 31.

The diffuser sheet 25a may include, as a base material, a film or a plate of polymethyl methacrylate resin, polycarbonate resin, polyvinyl chloride resin, polyester resin, or acetate resin, for example. A light diffusing layer is applied to be formed on this base material. The diffuser sheet 25a has a thickness of, for example, 30 μm-150 μm, and a high light transmittance. The diffuser sheet 25a is configured as a translucent film (sheet or plate) which scatters and diffuses light. The diffuser sheet 25a increases luminance in the frontward direction while providing a wide viewing angle, and transmits light from the light source to the entire surface of the liquid crystal display panel 22 in a uniform manner.

Each lens sheet 25b is made, for example, of an optical film produced by forming a prism pattern of an acrylic resin or a photopolymer on a surface of a highly transparent polyester film, and has a thickness of, for example, 40 μm-400 μm. The lens sheets 25b, which have a high light transmittance and are arranged to form a front portion of the backlight unit 30, concentrate the light emitted from the light source toward the user of the mobile telephone 1, and increase the luminance at the front (in the case where two lens sheets having prism patterns that are perpendicular to each other are used). The lens sheets 25b also enable, by re-reflection, the use of light that is outside the viewing angle and unused, and concentrate the light toward the user.

To maintain the optical effects (for example, light concentration and diffusion) of the optical sheet 25, it is necessary that the optical sheet 25 is not bonded to the front of the light guide plate 26 or the back of the backlight transparent sheet 31 within the effective light emitting area of the backlight unit 30. Note that in FIG. 1, the reference character X indicates a lighting area of the backlight unit 30. This lighting area X is larger than the liquid crystal active area A.

Next, a process of assembling the liquid crystal display unit 2 and the backlight unit 30 will be briefly described.

As shown in FIG. 1, first, the touch panel 21 is bonded to the back of the front cover 20 with an OCA 21a for touch panel.

Subsequently, the liquid crystal display panel 22 is bonded to the back of the touch panel 21 with an OCA 22a for LCD.

Next, the front of the fixing optical sheet 24 is bonded to the back of the liquid crystal display panel 22 with the optical clear adhesive tape 23. This bonding may be implemented using a clear adhesive instead of the optical clear adhesive tape 23. It is suitable to bond the multilayer optical sheet 25 in advance on the back of the body portion 24a of the optical fixing sheet 24, at a portion of the multilayer optical sheet 25 corresponding to the area outside the effective light-emitting area of the backlight unit 30. The optical sheet 25 may be bonded, at its portion corresponding to the area outside the effective light-emitting area, to the light guide plate 26, or may be merely positioned by the bezel 29 or any other component. In the case where the optical sheet 25 is arranged inward relative to the backlight transparent sheet 31 as in this embodiment, the optical sheet 25 does not have to be provided on the back of the body portion 24a of the fixing optical sheet 24.

Next, if the backlight transparent sheet 31 is to be provided as in this embodiment, the previously assembled backlight unit 30 is wrapped with the backlight transparent sheet 31 to be ready for installation. This previously assembled and wrapped backlight unit 30 is pressed onto the back of the fixing optical sheet 24, and positioned. At this process step in which the front of the backlight unit 30 is pressed onto the fixing optical sheet 24, since the base material itself of the fixing optical sheet 24 is not adhesive, the positioning can be performed easily.

Thereafter, the four extension portions 24b of the fixing optical sheet 24 are folded toward the back of the bezel 29, and bonded to the four side portions of the back with the extension portion-fixing double-sided tape 29a.

As shown in FIG. 4, the assembled liquid crystal display unit 2 and the assembled backlight unit 30 are housed in the front-side cabinet 3.

With this configuration, unlike the known art, it is no longer necessary to utilize the frame of the backlight unit holder as a region where the bonding is implemented. Consequently, even when using a liquid crystal display unit 2 having a narrow picture-frame, the entire display area may be made glow without having to widen the picture-frame region. Further, the fixing optical sheet 24 with which the backlight unit 30 is wrapped does not extend from the front of the liquid crystal display unit 2, but is bonded to the back of the liquid crystal display unit 2. This may prevent a decrease in the transmittance.

The front of each of the diffuser sheet 25a, the lens sheets 25b, and the light guide plate 26, and the back of the backlight transparent sheet 31 are not bonded to each other in the effective light-emitting area (the lighting area X) of the backlight unit 30. This may prevent the impediment to light concentration and light diffusion at the front of the backlight unit 30.

Further, the configuration of this embodiment may enable the light guide plate 26 to be arranged so widely as to reach the sidewall of the bezel 29, and may eliminate the need for providing the bonding region that is necessary in the known art. Thus, the backlight unit 30 having a narrow picture-frame may be obtained.

In addition, the configuration in which the extension portions 24b are bonded to all of the four side portions of the back of the backlight unit 30 substantially prevents the optical sheet 25, the diffuser sheet 25a, the lens sheets 25b, the light guide plate 26, the reflector sheet 27, and other components from being displaced in any direction. This may increase not only the accuracy of position of each component, but also the strength, and may hinder dust from entering the gaps between the components.

This embodiment is not configured such that the ends of the fixing optical sheet 24 are joined together, but has a configuration in which the back of the backlight unit 30, which has a high stiffness and is located frontward of the extension portions 24b of the fixing optical sheet 24, is utilized to join the fixing optical sheet 24. With this configuration, the liquid crystal display panel 22 and the backlight unit 30 may be reliably held without deteriorating the optical characteristics.

As can be seen from the foregoing, the mobile telephone 1 of this embodiment may achieve a narrow picture-frame of the liquid crystal display unit 2, while adopting a simple and easy-to-assemble structure.

### Second Embodiment

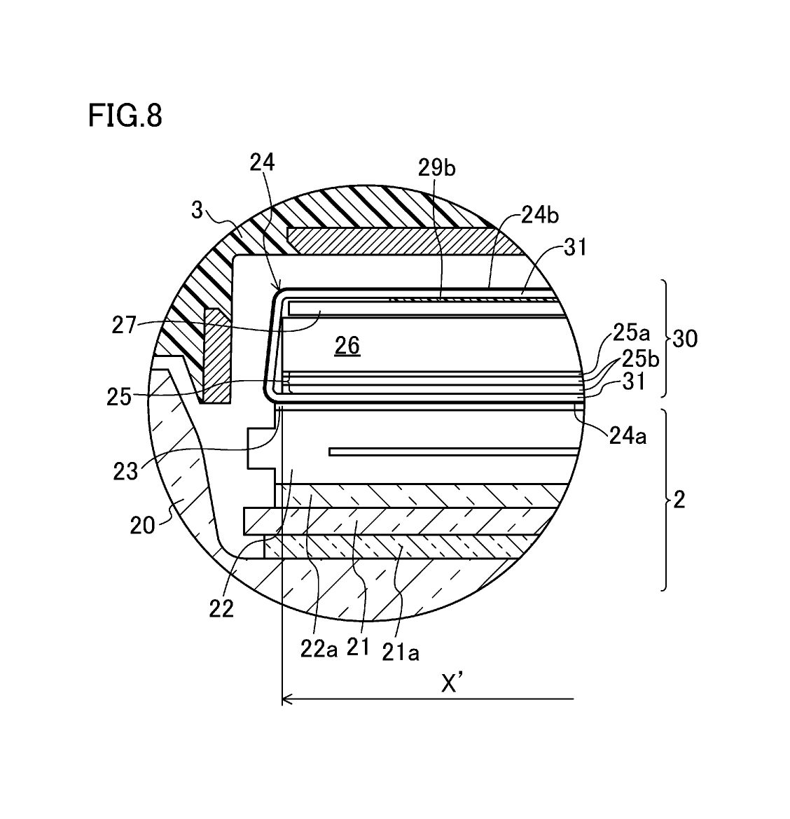

FIG. 8 shows a second embodiment of the present invention. This second embodiment is different from the first embodiment in that the second embodiment does not include the bezel 29. Note that in this embodiment, the same components as those shown in FIGS. 1-6 are denoted by the corresponding reference characters, and the detail description thereof is omitted herein.

Specifically, in this second embodiment, since the bezel 29 is not provided, each of the light guide plate 26 and the optical sheet 25 may be designed to have a larger outside shape than that in the first embodiment, provided that the outside shape of the backlight unit 30 remains unchanged. As a result, a lighting area X′ of this second embodiment is larger than that of the first embodiment.

In this case, in order to avoid a decrease in the stiffness due to the omission of the bezel 29, it is recommended to increase the stiffness of the reflector sheet 27. For example, it is suitable to increase the thickness the reflector sheet 27, or to form the reflector sheet 27 using a multilayer material comprised of a member having stiffness, such as sheet metal.

### Variation of Second Embodiment

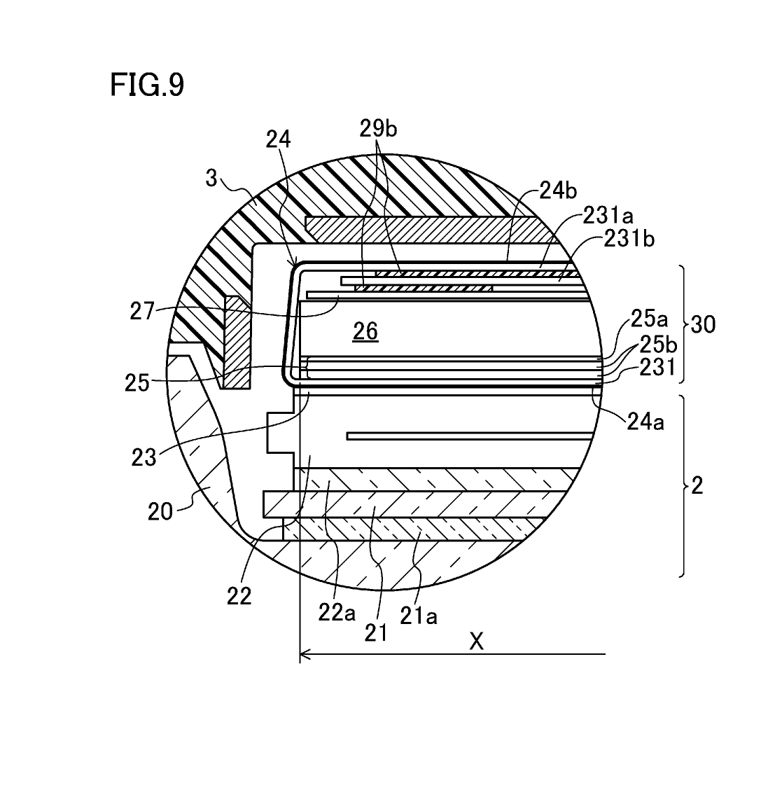

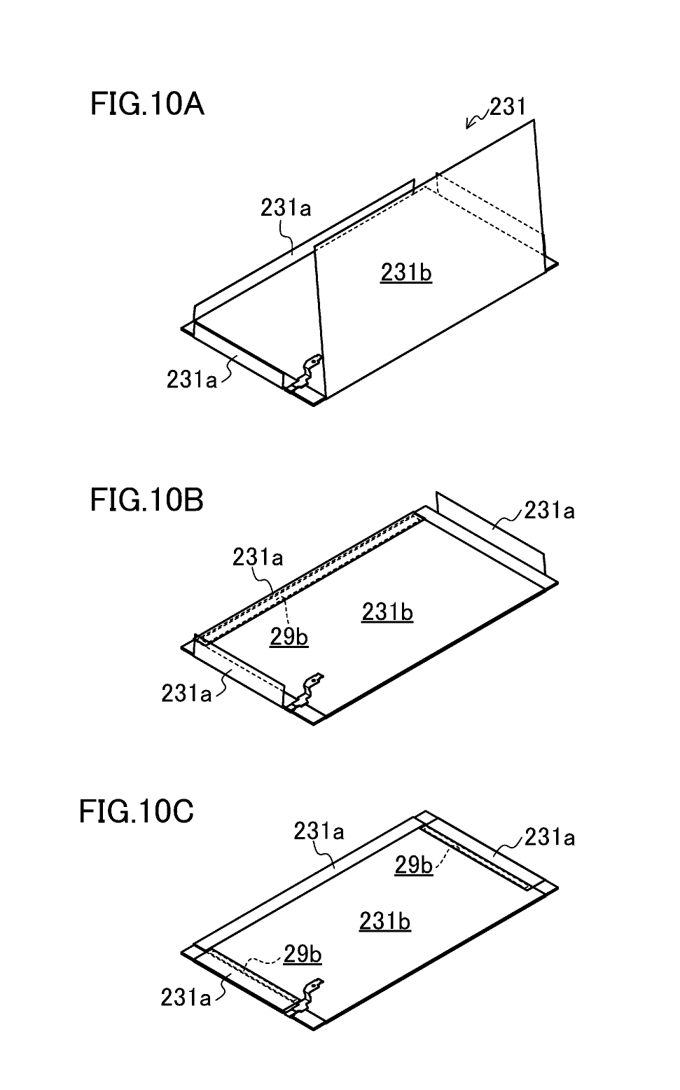

FIGS. 9-10C show a variation of the second embodiment of the present invention. This variation differs from the first embodiment in that a backlight transparent sheet 231 of this variation has a different shape from that in the first embodiment and is fixed differently from the first embodiment.

Specifically, in the first embodiment, the backlight transparent sheet 31 is bonded to the four side portions of the back of the bezel 29 with pieces of the transparent sheet-fixing double-sided tape 29b. On the other hand, in this variation, the backlight transparent sheet 231 has a short extension portion 231a extending from one of the two longitudinal sides and an additional extension portion 231b extending from the other longitudinal side so largely as to reach the short extension portion 231a. This additional extension portion 231b overlaps with the extension portion 231a to be joined together. More specifically, the additional extension portion 231b is first bonded with a piece of the transparent sheet-fixing double-sided tape 29b, and thereafter, the extension portion 231a is placed on and bonded to the previously bonded additional extension portion 231b with another piece of the transparent sheet double-sided tape 29b. It is also possible to first bond the extension portion 231a, and then to bond the additional extension portion 231b to the extension portion 231a. Note that a fixing optical sheet 24 similar to that of the first embodiment is suitably bonded with pieces of the extension portion-fixing double-sided tape 29a.

As can be seen, according to this variation, the burden of the reflector sheet 27 to which the transparent sheet-fixing double-sided tape 29b is attached may be reduced, and the components arranged inward relative to the backlight transparent sheet 231 are in close contact with each other and fixed in a steady manner. Therefore, the stiffness of the reflector sheet 27 does not have to be increased beyond necessity.

### Other Embodiments

The above embodiments of the present invention may have the following configurations.

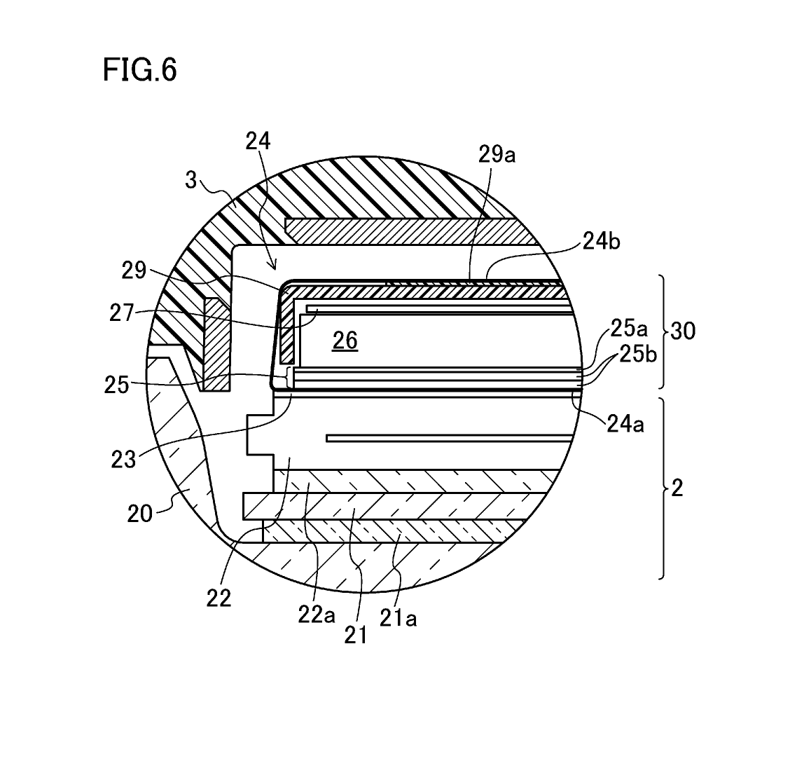

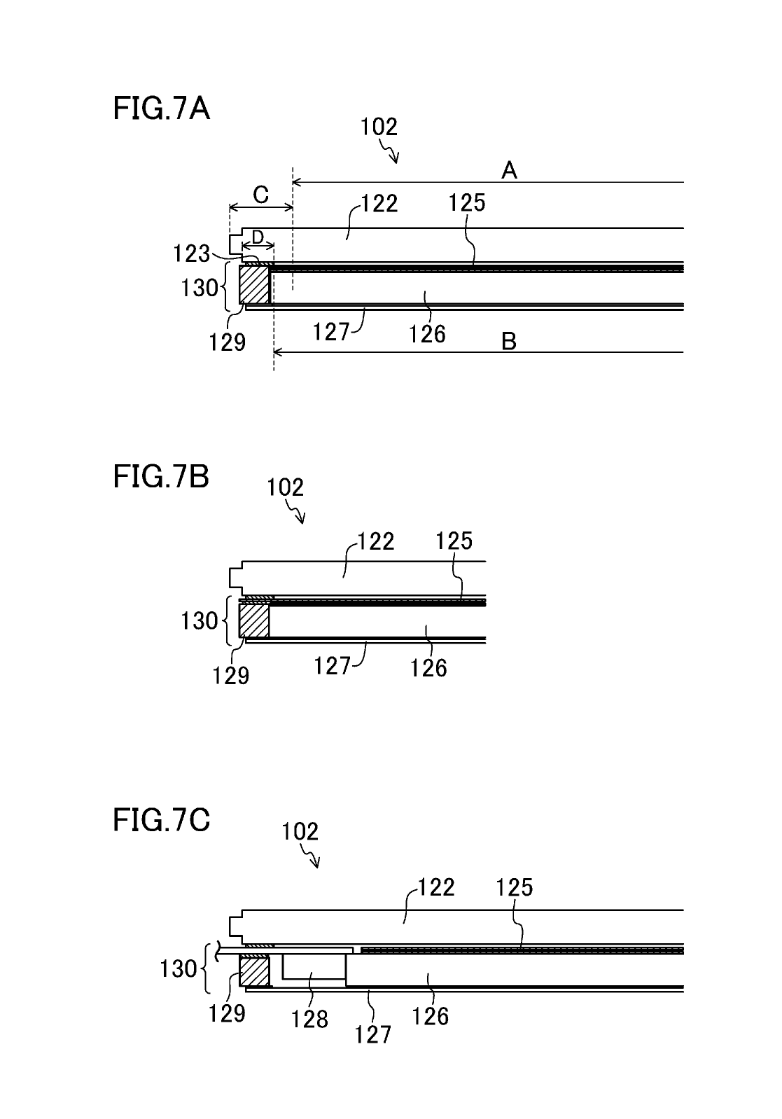

Specifically, in the embodiments described above, the backlight unit 30 is assembled into a unit. However, this is merely an example. As shown in FIG. 6, the backlight unit 30 of the present invention may be covered with the fixing optical sheet 24 without the backlight transparent sheet 31 being interposed. In this case, the optical sheet 25 is suitably bonded to the back of the body portion 24a of the fixing optical sheet 24. In this embodiment, although advantages like easy of handling due to preassembling the backlight unit 30 are not obtained, the number of components is reduced by the omission of the backlight transparent sheet 31, and the thickness may be reduced accordingly.

Further, each of the diffuser sheet 25a, the fixing optical sheet 24, and the backlight transparent sheet 31 may be made of a sheet having asperities on its surface. This may reduce the occurrence of interference fringes at the liquid crystal display unit, while maintaining the function of diffusing light.

In the embodiments described above, the electronic device is configured as the mobile telephone 1. However, this is merely an example. The electronic device of the present invention may be configured as a tablet terminal, a PHS (Personal Handy-phone System), a PDA (Personal Digital Assistant), a PC, a mobile tool, an electronic dictionary, a calculator, a game console, or any other electronic device. In particular, the electronic device of the present invention may be configured as a small liquid crystal display, a liquid crystal television, a Blu-ray (DVD) recorder, or any other electronic device.

Note that the embodiments described above are merely beneficial examples in nature, and are not intended to limit the scope, application, or uses of the present invention. The technical features specified in the foregoing description of the embodiments may be combined with each other, and such a combination may create a new technical feature.

### DESCRIPTION OF REFERENCE CHARACTERS

1 Mobile Telephone (Electronic Device)
2 Liquid Crystal Display Unit
3 Front-Side Cabinet
4 Backside Cabinet
5 Rear Cover
6 Rechargeable Battery
7 Main Substrate
20 Front Cover
21 Touch Panel
21a OCA for Touch Panel
22 Liquid Crystal Display Panel
22a OCA for LCD
23 Optical Clear Adhesive Tape
24 Fixing Optical Sheet
24a Body Portion
24b Extension Portion
25 Optical Sheet
25a Diffuser Sheet
25b Lens Sheet
26 Light Guide Plate
27 Reflector Sheet
28 Backlight Substrate
29 Bezel
29a Extension Portion-Fixing Double-Sided Tape
29b Transparent Sheet-Fixing Double-Sided Tape
30 Backlight Unit
31 Backlight Transparent Sheet
231 Backlight Transparent Sheet
231a Extension Portion
231b Additional Extension Portion

1. An electronic device provided with a liquid crystal display unit, the electronic device comprising:
a liquid crystal display panel having a rectangular plate shape;
a fixing optical sheet of which a front is bonded to a back of the liquid crystal display panel; and
a backlight unit which has a rectangular plate shape and which is fixed, with a front thereof being in contact with a back of the fixing optical sheet, wherein
the fixing optical sheet has extension portions each of which extends from an associated one of four sides of the fixing optical sheet and is designed to be folded back to cover an associated one of four side portions of a back of the backlight unit, and
in a state where the fixing optical sheet is bonded to the back of the liquid crystal display panel, each of the extension portions is bonded to the associated one of the four side portions of the back of the backlight unit.

2. The electronic device of claim 1, wherein
the fixing optical sheet includes a non-adhesive transparent base material having a film shape,
the base material has a rectangular body portion of which a front is bonded to the back of the liquid crystal display panel with double-sided tape or an adhesive,
the body portion has a back being in contact with the front of the backlight unit, and
the extension portions folded back and covering the four side portions of the back of the backlight unit are bonded to the four side portions of the back of the backlight unit with double-sided tape or an adhesive.

3. The electronic device of claim 1, wherein
the backlight unit includes a bezel which has a rectangular dish shape and on which a reflector sheet and a substrate having a light emitter are arranged,
a light guide plate is arranged frontward of the reflector sheet and the substrate, and
the light guide plate has a front covered with a backlight transparent sheet with which a front of the backlight unit is wrapped.

4. The electronic device of claim 3, wherein
the backlight transparent sheet has asperities on a portion being in contact with the fixing optical sheet.

5. A method for manufacturing an electronic device of claim 1, the method comprising:
bonding the front of the fixing optical sheet to the back of the liquid crystal display panel with double-sided tape or an adhesive,
pressing the backlight unit onto the back of the fixing optical sheet, and
folding back the extension portions of the fixing optical sheet to cover the four side portions of the back of the backlight unit, and boding the extension portions to the four side portions of the back of the backlight unit with double-sided tape or an adhesive.
